(19) United States
(12) Patent Application Publication
(10) Pub. No.: US 2025/0045794 A1
(43) Pub. Date: Feb. 6, 2025

(54) PROMOTIONAL INFORMATION DELIVERY METHOD AND RELATED DEVICE

(71) Applicant: Beijing Youzhuju Network Technology Co., Ltd., Beijing (CN)

(72) Inventor: Tao Zhou, Beijing (CN)

(21) Appl. No.: 18/788,806

(22) Filed: Jul. 30, 2024

(30) Foreign Application Priority Data
Jul. 31, 2023 (CN) 202310953176.8

(51) Int. Cl. G06Q 30/0242; G06Q 30/0241

(52) U.S. Cl. CPC G06Q 30/0242; G06Q 30/0249

(57) ABSTRACT

The present disclosure provides a promotional information delivery method. The method includes: determining at least one piece of candidate promotional information after a promotional information request sent by a client is received; separately determining a promotion gain quota of the at least one piece of candidate promotional information; determining target promotional information based on a promotion cost of the at least one piece of candidate promotional information and the corresponding promotion gain quota thereof; and pushing the target promotional information to the client. Based on the promotional information delivery method, the present disclosure further provides a promotional information delivery apparatus, a storage medium, and a program product.

### CROSS-REFERENCE TO RELATED APPLICATION(S)

This application claims priority to Chinese Application No. 202310953176.8 filed on Jul. 31, 2023, the disclosures of which are incorporated herein by reference in its entity.

### TECHNICAL FIELD

The present disclosure relates to the field of Internet technologies, and in particular to a promotional information delivery method, a promotional information delivery apparatus, a storage medium, and a program product.

### BACKGROUND ART

In order to provide users with better service quality, current applications can recommend various multimedia content to users. For example, a server of the applications can send various types of promotional information to the users. However, an amount of promotional information that can be pushed by the applications is usually limited and cannot be increased without limit. In addition, current promotional information delivery methods cannot effectively provide the users with more promotional information that may be of interest to the users. In light of these situations, competition is intensified among promotional information providers, which results in limited effectiveness of the promotional information delivery and increasing promotion cost of the promotional information.

### SUMMARY OF THE INVENTION

In view of this, an embodiment of the present disclosure provides a promotional information delivery method. For a single promotional information request, one or more pieces of promotional information that are of interest to users and that can bring greater promotion gains can be preferentially returned to a client, thereby improving the efficiency and effectiveness of promotional information delivery, while reducing the overall promotion cost of promotional information.

The promotional information delivery method according to the embodiment of the present disclosure may include: determining at least one piece of candidate promotional information after a promotional information request sent by a client is received; separately determining a promotion gain quota of the at least one piece of candidate promotional information; determining target promotional information based on a promotion cost of the at least one piece of candidate promotional information and the corresponding promotion gain quota thereof; and pushing the target promotional information to the client.

In some embodiments of the present disclosure, the separately determining a promotion gain quota of the at least one piece of candidate promotional information includes: separately determining whether the at least one piece of candidate promotional information satisfies a preset promotion condition; and in response to determining that the candidate promotional information satisfies the preset promotion condition, determining the promotion gain quota of the candidate promotional information based on a promotion gain of the candidate promotional information; or in response to determining that the candidate promotional information does not satisfy the preset promotion condition, setting the promotion gain quota of the candidate promotional information to a preset gain value.

In some embodiments of the present disclosure, the determining the promotion gain quota of the candidate promotional information based on a promotion gain of the candidate promotional information includes: summing promotion gains of the candidate promotional information within a first preset time period to obtain a first cumulative promotion gain corresponding to the candidate promotional information; summing promotion gain quotas of the candidate promotional information within the first preset time period to obtain a cumulative promotion gain quota consumption corresponding to the candidate promotional information; summing promotion gains of the candidate promotional information within a second preset time period to obtain a second cumulative promotion gain corresponding to the candidate promotional information; determining an average promotion gain of the candidate promotional information based on the second cumulative promotion gain; and determining the promotion gain quota of the candidate promotional information based on the first cumulative promotion gain, the cumulative promotion gain quota consumption, and the average promotion gain.

In some embodiments of the present disclosure, the determining the promotion gain quota of the candidate promotional information based on the first cumulative promotion gain, the cumulative promotion gain quota consumption, and the average promotion gain includes: subtracting the cumulative promotion gain quota consumption from the first cumulative promotion gain to obtain a remaining quantity of the promotion gain; and in response to the remaining quantity of the promotion gain being greater than or equal to the average promotion gain, using the average promotion gain as the promotion gain quota of the candidate promotional information; or in response to the remaining quantity of the promotion gain being less than the average promotion gain, using the remaining quantity of the promotion gain as the promotion gain quota of the candidate promotional information.

In some embodiments of the present disclosure, the determining the promotion gain quota of the candidate promotional information based on a promotion gain of the candidate promotional information includes: summing promotion gains of the candidate promotional information within a first preset time period to obtain a first cumulative promotion gain corresponding to the candidate promotional information; summing promotion gain quotas of the candidate promotional information within the first preset time period to obtain a cumulative promotion gain quota consumption corresponding to the candidate promotional information; and determining the promotion gain quota of the candidate promotional information based on the first cumulative promotion gain and the cumulative promotion gain quota consumption.

In some embodiments of the present disclosure, the determining the promotion gain quota of the candidate promotional information based on the first cumulative promotion gain and the cumulative promotion gain quota consumption includes: subtracting the cumulative promotion gain quota consumption from the first cumulative promotion gain to obtain a remaining quantity of the promotion gain; and using the remaining quantity of the promotion gain as the promotion gain quota of the candidate promotional information.

In some embodiments of the present disclosure, the determining the promotion gain quota of the candidate promotional information based on a promotion gain of the candidate promotional information includes: summing promotion gains of the candidate promotional information within a second preset time period to obtain a second cumulative promotion gain corresponding to the candidate promotional information; determining an average promotion gain of the candidate promotional information based on the second cumulative promotion gain; and determining the promotion gain quota of the candidate promotional information based on the average promotion gain.

In some embodiments of the present disclosure, the determining target promotional information based on a promotion cost of the at least one piece of candidate promotional information and the corresponding promotion gain quota thereof includes: separately summing the promotion cost of the at least one piece of candidate promotional information and the corresponding promotion gain quota thereof, to obtain a promotion selection indicator for the at least one piece of candidate promotional information; and using, as the target promotional information, candidate promotional information with a largest promotion selection indicator from the at least one piece of candidate promotional information.

Corresponding to the promotional information delivery method described above, some embodiments of the present disclosure further provide a promotional information delivery apparatus. The promotional information delivery apparatus may include:
a recall module configured to determine at least one piece of candidate promotional information after a promotional information request sent by a client is received;
a gain quota determination module configured to separately determine a promotion gain quota of the at least one piece of candidate promotional information;
a ranking module configured to determine target promotional information based on a promotion cost of the at least one piece of candidate promotional information and the corresponding promotion gain quota thereof; and
a pushing module configured to push the target promotional information to the client.

An embodiment of the present disclosure further provides an electronic device. The electronic device includes: a memory, a processor, and a computer program stored on the memory and executable on the processor, where the computer program, when executed by the processor, causes the promotional information delivery method described above to be implemented.

An embodiment of the present disclosure further provides a non-transitory computer-readable storage medium storing computer instructions, where the computer instructions are used to cause a computer to perform the promotional information delivery method described above.

An embodiment of the present disclosure further provides a computer program product, including computer program instructions that, when executed on a computer, cause the computer to perform the promotional information delivery method described above.

As can be seen from the above, according to the promotional information delivery method and the related device described in the embodiments of the present disclosure, first, the candidate promotional information that is of interest to the user may be obtained after the promotional information request from the client is received. Then, a promotion gain quantity of each piece of candidate promotional information is determined based on a promotion gain of the piece of candidate promotional information within a predetermined time period. Finally, the target promotional information is selected and delivered based on a promotion cost and the promotion gain quantity of each piece of candidate promotional information.

With the method described above, a promotion gain quantity can be set for promotional information, such as affiliate promotional information, that can bring a promotion gain, and therefore preferential delivery thereof is implemented. A higher promotion gain of the promotional information leads to a higher set promotion gain quantity and also a higher chance of winning a delivery. In this way, the probability of delivering the promotional information, such as the affiliate promotional information, that can bring the promotion gain can be increased without an increase in the promotion cost of the promotional information, so that the competitiveness of such a type of promotional information in delivery is improved, thereby bringing more benefits for the promotional information delivery platform. From another perspective, promotional information providers can increase the impression probability of their promotional information without paying more. For the promotional information providers, the promotion cost of the promotional information is reduced effectively in essence.

Furthermore, the promotional information, such as the affiliate promotional information, that can bring the promotion gain is often combined promotional information that combines a plurality of pieces of promotional information. In other words, the promotional information delivery method described above makes it possible to preferentially return to the client the information such as the affiliate promotional information that contains a plurality of pieces of promotional information of interest to the user, so that the user can be provided with richer information for decision making. Therefore, the delivery method also improves the efficiency and effectiveness of the promotional information delivery.

### BRIEF DESCRIPTION OF DRAWINGS

In order to more clearly describe the technical solutions in the present disclosure or in the related art, the accompanying drawings for describing the embodiments or the related art will be briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of an application scenario of promotional information delivery according to an embodiment of the present disclosure;

FIG. 2 is a schematic diagram of an affiliate page according to some embodiments of the present disclosure;

FIG. 3 shows a procedure of implementing a promotional information delivery method according to some embodiments of the present disclosure;

FIG. 4 shows a procedure of implementing a method for separately determining a promotion gain quota of at least one piece of candidate promotional information according to an embodiment of the present disclosure;

FIG. 5 shows a procedure of implementing a method for determining a promotion gain quota of candidate promotional information based on a promotion gain of the candidate promotional information according to some embodiments of the present disclosure;

FIG. 6 shows a procedure of implementing a method for determining a promotion gain quota of candidate promotional information based on a promotion gain of the candidate promotional information according to some other embodiments of the present disclosure;

FIG. 7 shows a procedure of implementing a method for determining a promotion gain quota of candidate promotional information based on a promotion gain of the candidate promotional information according to yet other embodiments of the present disclosure;

FIG. 8 shows a procedure of implementing a method for determining target promotional information based on a promotion cost and a corresponding promotion gain quota of candidate promotional information according to some embodiments of the present disclosure;

FIG. 9 shows an internal structure of a promotional information delivery apparatus according to an embodiment of the present disclosure; and

FIG. 10 is a schematic diagram of a hardware structure of a more specific electronic device according to some embodiments of the present disclosure.

### DETAILED DESCRIPTION OF THE INVENTION

In order to make the objects, technical solutions, and advantages of the present disclosure clearer, the present disclosure is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include” or “comprise” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions in the embodiments of the present disclosure, the user shall be informed of the type, range of use, use scenarios, etc., of involved personal information in an appropriate manner, and the authorization of the user shall be obtained.

For example, in response to reception of an active request from a user, prompt information is sent to the user to clearly inform the user that the requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

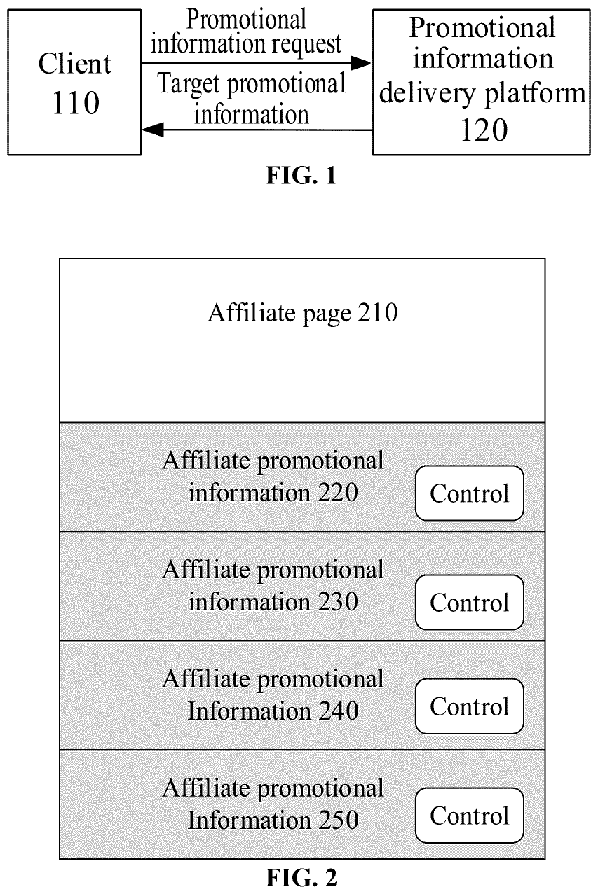

FIG. 1 is a schematic diagram of an application scenario of promotional information delivery according to some embodiments of the present disclosure. In the application scenario shown in FIG. 1, a user may first send a promotional information request by using a client. For example, while the user is browsing through a feed on the client 110, one or more spaces for promotional information delivery are typically reserved in the feed browsed by the user. When the user reaches or is about to reach the space reserved for the promotional information delivery, the client 110 may send the promotional information request to a promotional information delivery platform 120. In this case, the promotional information delivery platform 120 selects a piece of target promotional information from massive promotional information stored thereon for delivery, and returns the target promotional information to the client 110. The client 110 displays the target promotional information to the user at the space for the promotional information delivery that is reserved in the feed. It should be noted that the above scenario is illustrated by using an example in which the promotional information delivery is implemented while the user is browsing through the feed. In actual applications, the client may also send the promotional information request to the promotional information delivery platform 120 when another preset operation is triggered, for example, based on a search request of the user, or based on a request of the user to open a client application or a page, etc. The application scenario of the promotional information delivery is not limited in the embodiments of the present disclosure.

At present, the promotional information delivery platform 120 may usually display different promotional information to different users based on different user groups or different promotion costs paid by promotional information providers. In general, a process in which the promotional information delivery platform 120 selects the target promotional information needs to go through four procedures in sequence, namely, recall, pre-ranking, ranking, and display. The recall procedure is responsible for finding at least one piece of promotional information that can be pushed to the user from the massive promotional information stored for delivery. In general, in order to ensure the effectiveness of the promotional information delivery, the promotional information that can be pushed to the user is usually related to a characteristic such as an attribute or a historical operation of the client that sends the promotional information request or the user. The pre-ranking procedure is responsible for a preliminary selection on the promotional information that can be pushed to the user to obtain at least one piece of candidate promotional information, thereby reducing the processing complexity of the ranking procedure. The ranking procedure is responsible for finding best target promotional information from the at least one piece of candidate promotional information. The display procedure is responsible for returning the target promotional information to the client, to display to the user the found target promotional information.

It can be understood that in the process of promotional information delivery, a promotional information provider needs to pay a certain fee to the promotional information delivery platform, and the fee may be understood as a promotion cost paid by the promotional information provider. In some cases, a promotion cost of a piece of promotional information may be related to a number of times for which the promotional information is displayed. The promotion cost then may also be referred to as a cost per impression, where each display of the promotional information may also be referred to as an impression of the promotional information. For example, in the embodiments of the present disclosure, the cost per impression for the promotional information may be a fee paid for every thousand displays (effective cost per mile, eCPM). In some other cases, the promotion cost of a piece of promotional information may be related to some other operational parameters of the promotional information, such as a number of clicks on the promotional information or a number of conversions of the promotional information. It should be noted that how the promotional information is charged is not limited in the embodiments of the present disclosure. In other words, the specific manner in which the promotion cost of the promotional information is calculated in the embodiments of the present disclosure does not affect the specific implementation of the method according to the embodiments of the present disclosure.

It can be understood that in order to ensure the user's experience of browsing the feed, there should not be too many spaces for promotional information delivery reserved in the feed or on a page. Therefore, the number of spaces in which the promotional information may be delivered is limited. However, the existing promotional information delivery methods usually cannot accurately provide the user with more promotional information that may be of interest to the user. In light of the contradiction, competition is intensified among promotional information providers, which results in limited effectiveness of the promotional information delivery and increasing promotion cost of the promotional information.

In order to solve the above problem that the user cannot be provided with more promotional information that may be of interest to the user, the promotional information delivery platform 120 provides an affiliate promotion method in addition to in-feed promotion. Promotional information using such a promotion method is also referred to as affiliate promotional information or affiliate advertisements. Affiliate promotion usually refers to an aggregated promotion method in which a plurality of pieces of promotional information are contained in an affiliate page popped up after the user leaves their information on a landing page of in-feed promotional information. The landing page of the in-feed promotional information is a page displaying the in-feed promotional information. In order to distinguish the in-feed promotional information from a plurality of pieces of promotional information displayed subsequently in the affiliate page, in the embodiments of the present disclosure, the above in-feed promotional information first displayed to the user is referred to as primary promotional information, and the promotional information subsequently displayed to the user on the affiliate page is referred to as affiliate promotional information. In other words, the user may first view the primary promotional information on the landing page of the primary promotional information, and may leave their information by submitting a form. Here, leaving their information refers to submitting information on the landing page of the primary promotional information, so that a primary promotional information provider (e.g., an advertiser) can obtain the information filled in by the user with the authorization of the user. As described above, in the affiliate promotion method, after the user leaves their information on a landing page of a piece of primary promotional information, the affiliate page may be further popped up, to display to the user the plurality of pieces of affiliate promotional information contained in the affiliate page. In general, the plurality of pieces of affiliate promotional information displayed on the affiliate page usually belong to the same industry as the primary promotional information, but they are not competitors to each other. For example, both the primary promotional information and the plurality of pieces of affiliate promotional information displayed on the affiliate page are promotional information for the home furnishing industry, but the primary promotional information is promotional information for furniture, while the affiliate promotional information is promotional information for home decoration, etc. In actual applications, the above affiliate promotion method is particularly suitable for delivery of lead-type promotional information. This is because decision-making is important for the lead-type promotional information, and the user may often make a horizontal comparison between a plurality of pieces of promotional information before a conversion of the promotional information is completed. Therefore, when the user leaves their information for the primary promotional information, the plurality of pieces of affiliate promotional information are further displayed to the user to facilitate the user making the horizontal comparison, thereby helping to enhance the user experience. In actual situations, when the user leaves their information on the landing page of a piece of primary promotional information, it typically means that the user has an interest in the piece of primary promotional information. Generally, there is a high probability that the user also has an interest in a plurality of pieces of additional promotional information further displayed on the affiliate page that are belong to the same industry. In this case, a probability that a further operation of the user such as clicking, leaving their information, or even converting generated after browsing the plurality of pieces of affiliate promotional information can be significantly increased. Therefore, the affiliate promotion method can provide the user with more promotional information that may be of interest to the user, without an increase in the number of spaces for promotional information preset in the feed. As a result, a plurality of lead conversions can be generated in a single promotional information request, which greatly improves the promotion efficiency and effectiveness of the promotional information.

To facilitate aggregated display of the plurality of pieces of affiliate promotional information on the affiliate page, the pieces of affiliate promotional information are typically displayed in the form of cards. FIG. 2 is a schematic diagram of an affiliate page according to an embodiment of the present disclosure. As shown in FIG. 2, a plurality of pieces of affiliate promotional information in the form of cards may be displayed on an affiliate page 210, namely, affiliate promotional information 220, affiliate promotional information 230, affiliate promotional information 240, and affiliate promotional information 250. As an optional example, each piece of affiliate promotional information in the form of a card may include text information related to the affiliate promotional information, such as a name, an identifier, and a description; and may further include multimedia content related to the affiliate promotional information, such as an image or a video. In general, the affiliate promotional information may further include a control that may further display its details, so that the user further obtains the details related to the affiliate promotional information. It can be understood that FIG. 2 is merely an example of the affiliate promotional information, and the specific form of the affiliate promotional information is not limited in the embodiments of the present disclosure. It can be seen from FIG. 2 described above that a plurality of pieces of affiliate promotional information can be simultaneously displayed to the user on the same affiliate page, that is, more promotional information that may be of interest to the user can be provided to the user at a time.

Furthermore, from the perspective of the promotional information delivery platform, a single promotional information delivery can further display the affiliate page containing the plurality of pieces of affiliate promotional information to the user, and possibly generate a plurality of lead conversions. Therefore, the promotional information delivery platform can further charge other affiliate promotional information providers without increasing a fee of an original in-feed promotional information provider. In other words, the delivery of the affiliate promotional information can usually generate a higher value without an increase in the promotion cost of the promotional information. Therefore, from this perspective, during the selection of the target promotional information, the affiliate promotional information should be given a higher chance of winning.

Based on the above considerations, an embodiment of the present disclosure provides a promotional information delivery method. The method may be performed by the promotional information delivery platform 120.

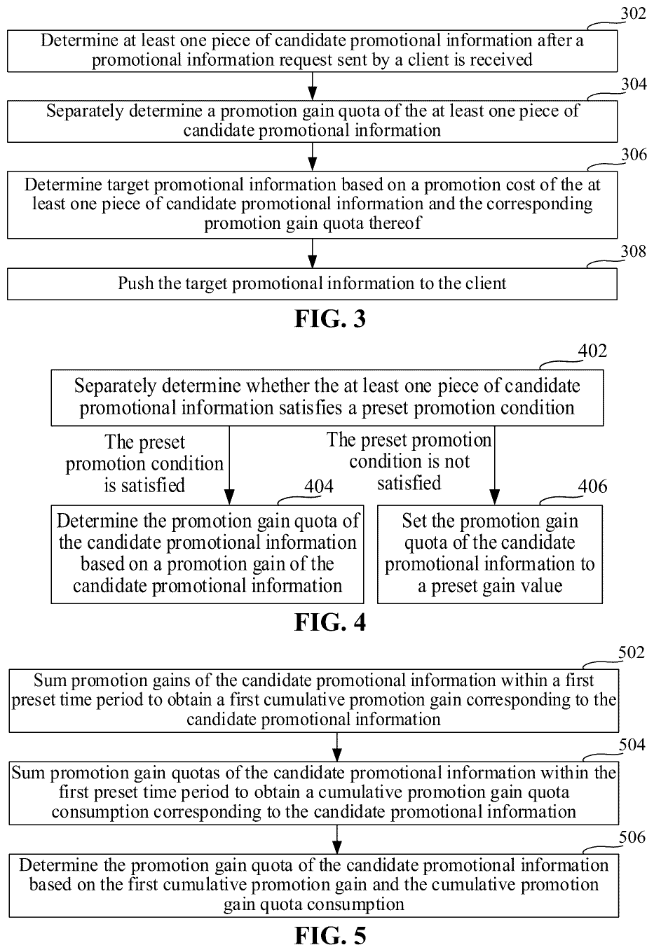

FIG. 3 shows a procedure of implementing a promotional information delivery method according to an embodiment of the present disclosure. As shown in FIG. 3, the promotional information delivery method may include the following steps.

At step 302, at least one piece of candidate promotional information is determined after a promotional information request sent by a client is received.

At step 304, a promotion gain quota of each of the at least one piece of candidate promotional information is determined.

At step 306, target promotional information is determined based on a promotion cost of the at least one piece of candidate promotional information and the corresponding promotion gain quota thereof.

At step 308, the target promotional information is pushed to the client.

The steps of the information delivery method are described in detail below with reference to the accompanying drawings and specific examples.

For step 302, as described above, after the promotional information request is received, the promotional information delivery platform 120 may determine the at least one piece of candidate promotional information through a recall procedure and a pre-ranking procedure. In some embodiments of the present disclosure, the recall procedure and the pre-ranking procedure may be performed based on a characteristic such as attribute information and historical operation information of the client that sends the promotional information request or the user. Specifically, step 302 may be implemented by using various existing recall and pre-ranking methods, which are not described in detail herein.

For step 304, specifically, in the embodiments of the present disclosure, the promotion gain quota of the candidate promotional information is an estimated value of a promotion gain that can be obtained from delivering a piece of candidate promotional information for the current promotional information request. As described above, for the promotional information delivery platform, after a piece of primary promotional information is delivered, if the user completes leaving their information, an affiliate page containing a plurality of pieces of affiliate promotional information may further be displayed to the user. The user may further perform, for the affiliate promotional information on the affiliate page, a further operation such as clicking, leaving their information, or even converting. In this case, in addition to charging a fee A related to the primary promotional information, the promotional information delivery platform may further charge a fee B related to the plurality of pieces of other affiliate promotional information displayed on the affiliate page. In the embodiments of the present disclosure, the fee B related to the plurality of pieces of other affiliate promotional information displayed on the affiliate page is referred to as a promotion gain of the primary promotional information. That is, the promotion gain is an additional benefit that can be brought to the promotional information delivery platform from delivering the primary promotional information at a promotion cost of the primary promotional information.

It can be understood that during the selection of the target promotional information, a higher chance of winning should be given to promotional information that can obtain a higher promotion gain, so that a higher benefit can be brought to the promotional information delivery platform without an increase in the promotion costs of the promotional information providers. However, an actual promotion gain of a piece of promotional information can be determined only after it is delivered, and cannot be determined accurately in advance. Thus, in the embodiments of the present disclosure, it is necessary to separately estimate in advance the promotion gain of the at least one piece of candidate promotional information, i.e. to predetermine its promotion gain quota, and then to use the predetermined promotion gain quota in place of an actual promotion gain to perform ranking on the at least one piece of candidate promotional information, thereby determining the final target promotional information that wins.

FIG. 4 shows a procedure of implementing a method for separately determining a promotion gain quota of at least one piece of candidate promotional information according to some embodiments of the present disclosure. As shown in FIG. 4, the method may include the following steps.

At step 402, it is separately determined whether the at least one piece of candidate promotional information satisfies a preset promotion condition.

As described above, the affiliate promotional information is typically suitable for the lead-type promotional information, and the affiliate page may be popped up only after the user leaves their information for the primary promotional information. In other words, not all promotional information may trigger the delivery of the affiliate promotional information, and therefore, not all promotional information may generate the promotion gain. Therefore, the determination on whether the preset promotion condition is satisfied, as described in step 402, is primarily used for selecting candidate promotional information that can generate the promotion gain.

In some embodiments of the present disclosure, the preset promotion condition may be specifically that the candidate promotional information is or is not the lead-type promotional information; or that the candidate promotional information supports or does not support the affiliate promotional information. It should be noted that the preset promotion condition is set according to actual applications. Although it may be set as the condition described above in the application scenario of the affiliate promotional information, it may be set as other conditions in other application scenarios in which other promotion gains can be generated. In other words, although the embodiments of the present disclosure are illustrated by taking the affiliate promotional information as an example, the method provided in the embodiments of the present disclosure is not limited to the scenario of affiliate promotional information delivery, and the method is equally applicable to other types of promotional information that can bring promotion gains, except that adaptive updates need to be made to the above preset promotion condition.

During a specific implementation, since whether a piece of promotional information is the lead-type promotional information and/or supports the affiliate promotional information is usually set in its attribute information, the promotional information delivery platform 120 may separately determine whether the at least one piece of candidate promotional information satisfies the preset promotion condition based on attribute information of the at least one piece of candidate promotional information.

At step 404, in response to determining that the candidate promotional information satisfies the preset promotion condition, the promotion gain quota of the candidate promotional information is determined based on a promotion gain of the candidate promotional information.

At step 406, in response to determining that the candidate promotional information does not satisfy the preset promotion condition, the promotion gain quota of the candidate promotional information is set to a preset gain value.

In the embodiments of the present disclosure, the preset gain value may be set to a fixed value, for example, 0. In other words, the candidate promotional information that does not satisfy the preset promotion condition may be considered as information that cannot bring a promotion gain, and thus its promotion gain quota may be set to a fixed value, for example, directly to 0.

Specifically, in the embodiments of the present disclosure, the promotional information delivery platform 120 may perform step 404 using a variety of methods; that is, the promotion gain quota of the candidate promotional information may be determined using a variety of methods based on the promotion gain of the candidate promotional information. A detailed description will be given below with reference to the accompanying drawings and examples.

FIG. 5 shows a procedure of implementing a method for determining a promotion gain quota of candidate promotional information based on a promotion gain of the candidate promotional information according to some embodiments of the present disclosure. As shown in FIG. 5, the method may include the following steps.

At step 502, promotion gains of the candidate promotional information within a first preset time period are summed to obtain a first cumulative promotion gain corresponding to the candidate promotional information.

In the embodiments of the present disclosure, the first preset time period is a time period from a preset first time point to a current time point. For example, the preset first time point may be zero o'clock of a current day. Then, the first preset time period is a time period from zero o'clock of the current day to the current time point. It should be noted that the first time point may alternatively be set to other time points according to actual needs. The specific point in time of the first time point is not limited in the present disclosure.

In step 502, summing the promotion gains of the candidate promotional information within the first preset time period refers to summing actual promotion gains generated by the candidate promotional information within the first preset time period. The first cumulative promotion gain is a sum of the actual promotion gains generated by the candidate promotional information within the first preset time period. For example, if a piece of candidate promotional information is delivered three times within the first preset time period, and actual promotion gains generated by the three deliveries are 10, 5, and 6, respectively, a first cumulative promotion gain of the candidate promotional information is determined as 21 (10+5+6=21). As can be seen, since the first preset time period is the time period from the preset first time point to the current time point, the first cumulative promotion gain can basically reflect the real-time performance of the candidate promotional information.

At step 504, promotion gain quotas of the candidate promotional information within the first preset time period are summed to obtain a cumulative promotion gain quota consumption corresponding to the candidate promotional information.

In step 504, summing the promotion gain quotas of the candidate promotional information within the first preset time period refers to summing promotional information gain quotas determined for deliveries of the candidate promotional information within the first preset time period. The cumulative promotion gain quota consumption is a sum of estimated values of the promotion gains determined for the candidate promotional information within the first preset time period. For example, if a piece of candidate promotional information is delivered three times within the first preset time period, and promotion gain quotas determined for the three deliveries are 0, 10, and 5, respectively, a cumulative promotion gain quota consumptions of the candidate promotional information is determined as 15 (0+10+5=15).

At step 506, the promotion gain quota of the candidate promotional information is determined based on the first cumulative promotion gain and the cumulative promotion gain quota consumption.

Specifically, in the embodiments of the present disclosure, the cumulative promotion gain quota consumption may be first subtracted from the first cumulative promotion gain to obtain a remaining quantity of the promotion gain. Then, the remaining quantity of the promotion gain is used as the promotion gain quota of the candidate promotional information. Continuing with the example described above, if a piece of candidate promotional information is delivered three times within the first preset time period, actual promotion gains generated by the three deliveries are 10, 5, and 6, respectively, and promotion gain quotas determined for the three deliveries are 0, 10, and 5, respectively, a first cumulative promotion gain of the candidate promotional information may be determined as 21 (10+5+6=21), and a cumulative promotion gain quota consumptions of the candidate promotional information is determined as 15 (0+10+5=15). In this case, in a new round of promotional information delivery, the promotion gain quota of the candidate promotional information may be determined as 6 (21−15=6).

As can be seen from the above process, in the above method, the sum of the actual promotion gains that have been generated by the candidate promotional information within the first preset time period is used as an upper limit for calculation of the estimated value of the promotion gain that can be generated by the candidate promotional information in the next delivery, so that the sum of the estimated values of the actual promotion gains that can be generated by the candidate promotional information within the first preset time period is always less than the sum of the actual promotion gains generated by the candidate promotional information within the first preset time period and cannot exceed the sum of the actual generated promotion gains, which can effectively ensure the accuracy of estimated promotion gains.

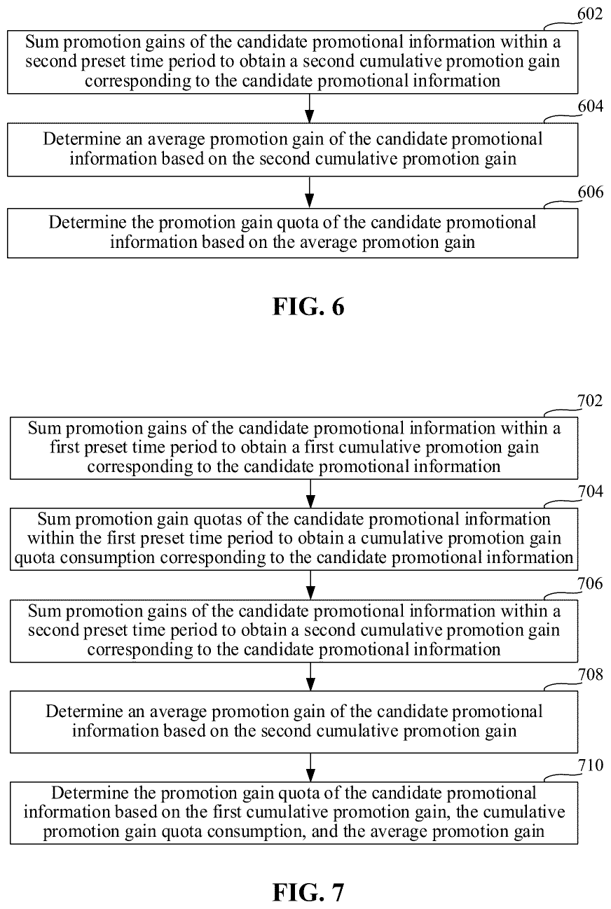

FIG. 6 shows a procedure of implementing a method for determining a promotion gain quota of candidate promotional information based on a promotion gain of the candidate promotional information according to some other embodiments of the present disclosure. As shown in FIG. 6, the method may include the following steps.

At step 602, promotion gains of the candidate promotional information within a second preset time period are summed to obtain a second cumulative promotion gain corresponding to the candidate promotional information.

In the embodiments of the present disclosure, the second preset time period is a time period from a preset second time point to a preset third time point. For example, the preset second time point may be 00:00:00 of a previous day. For example, the preset third time point may be 24:59:59 of the previous day. Then, the second preset time period is a time period from zero o'clock of the previous day to 24 o'clock of the previous day, that is, the whole previous day. It should be noted that the second time point and third time point may alternatively be set to other time points according to actual needs. For example, the second preset time period is set to previous T days, where T is a natural number. In general, the second preset time period is earlier than the first preset time period.

In step 602, summing the promotion gains of the candidate promotional information within the second preset time period refers to summing actual promotion gains generated by the candidate promotional information within the second preset time period. The second cumulative promotion gain is a sum of the actual promotion gains generated by the candidate promotional information within the second preset time period. For example, if a piece of candidate promotional information is delivered ten times within the second preset time period, and actual promotion gains generated by the ten deliveries are 10, 5, 6, 8, 9, 6, 11, 4, 7, and 9, respectively, a second cumulative promotion gain of the candidate promotional information is determined as 75 (10+5+6+8+9+6+11+4+7+9=75).

At step 604, an average promotion gain of the candidate promotional information is determined based on the second cumulative promotion gain.

In step 604, a quotient of the second cumulative promotion gain and a number of times for which the candidate promotional information is delivered within the second preset time period may be used as the average promotion gain. For example, if a piece of candidate promotional information is delivered ten times within the second preset time period, and actual promotion gains generated by the ten deliveries are 10, 5, 6, 8, 9, 6, 11, 4, 7, and 9, respectively, a second cumulative promotion gain of the candidate promotional information may be determined as 75 (10+5+6+8+9+6+11+4+7+9=75). Further, an average promotion gain of the candidate promotional information may be determined as 7.5 (75/10=7.5). As can be seen, the average promotion gain can basically reflect the historical performance of the candidate promotional information.

At step 606, the promotion gain quota of the candidate promotional information is determined based on the average promotion gain.

In step 606, the average promotion gain may be directly used as the promotion gain quota of the candidate promotional information. For example, continuing with the above example, after the average promotion gain of a piece of candidate promotional information is determined as 7.5, the promotion gain quota of the candidate promotional information may be directly determined as 7.5. Alternatively, in step 606, the average promotion gain may be multiplied by a preset gain estimation coefficient, and the product is used as the promotion gain quota of the candidate promotional information. In some embodiments of the present disclosure, the gain estimation coefficient may be set based on a historical performance trend of the candidate promotional information. For example, if the promotion gain of the candidate promotional information has historically shown an increasing trend, the gain estimation coefficient may be set to a value greater than 1; or if the promotion gain of the candidate promotional information has historically shown a decreasing trend, the gain estimation coefficient may be set to a value less than 1. Still alternatively, in some other embodiments of the present disclosure, to avoid an overestimate of the promotion gain, the gain estimation coefficient may be uniformly set to a value less than 1.

As can be seen from the above process, in the above method, the promotion gain that can be generated by the candidate promotional information when delivered within the first preset time period is estimated based on the average value of the actual promotion gains generated by the delivery of the candidate promotional information within the second preset time period. That is, the estimated value for the candidate promotional information is estimated based on the historical performance of the candidate promotional information. Such an estimation method has a certain degree of accuracy in general, but cannot ensure that the sum of the estimated promotion gains that can be generated by the candidate promotional information within the first preset time period is always less than the sum of the actual promotion gains generated by the candidate promotional information within the first preset time period, and thus an overestimate of the promotion gain may occur.

FIG. 7 shows a procedure of implementing a method for determining a promotion gain quota of candidate promotional information based on a promotion gain of the candidate promotional information according to some other embodiments of the present disclosure. As shown in FIG. 7, the method may include the following steps.

At step 702, promotion gains of the candidate promotional information within a first preset time period are summed to obtain a first cumulative promotion gain corresponding to the candidate promotional information.

At step 704, promotion gain quotas of the candidate promotional information within the first preset time period are summed to obtain a cumulative promotion gain quota consumption corresponding to the candidate promotional information.

Reference may be made to steps 502 and 504 for the specific implementation methods of steps 702 and 704, and details are not repeated herein.

At step 706, promotion gains of the candidate promotional information within a second preset time period are summed to obtain a second cumulative promotion gain corresponding to the candidate promotional information.

At step 708, an average promotion gain of the candidate promotional information is determined based on the second cumulative promotion gain.

Reference may be made to steps 602 and 604 for the specific implementation methods of steps 706 and 708, and details are not repeated herein.

At step 710, the promotion gain quota of the candidate promotional information is determined based on the first cumulative promotion gain, the cumulative promotion gain quota consumption, and the average promotion gain.

Specifically, step 710 may include:
first, subtracting the cumulative promotion gain quota consumption from the first cumulative promotion gain to obtain a remaining quantity of the promotion gain; and
second, in response to the remaining quantity of the promotion gain being greater than or equal to the average promotion gain, using the average promotion gain as the promotion gain quota of the candidate promotional information;
or in response to the remaining quantity of the promotion gain being less than the average promotion gain, using the remaining quantity of the promotion gain as the promotion gain quota of the candidate promotional information.

Again, a specific example is used below for illustration.

If it is determined that a piece of candidate promotional information has an average promotion gain of 7.5 within the second preset time period and has not been delivered within the first preset time period. In this case, as can be seen, when a round of promotional information delivery is to be performed, the candidate promotional information currently has a first cumulative promotion gain of 0 and also a cumulative promotion gain quota consumption of 0. Based on the method shown in FIG. 7 above, it may be determined that a remaining quantity of the promotion gain of the candidate promotional information in the current delivery is 0 (0−0=0), and therefore, a promotion gain quantity of the candidate promotional information in the current delivery is 0. Further, if an actual promotion gain generated by the candidate promotional information after an actual first delivery is 10, when a new round of promotional information delivery is to be performed, it may be determined that the candidate promotional information currently has a first cumulative promotion gain of 10 and still a cumulative promotion gain quota consumptions of 0. Based on the above method, it may be determined that the remaining quantity of the promotion gain of the candidate promotional information in the current delivery is 10 (10−0=0), and therefore, the promotion gain quantity of the candidate promotional information in the current delivery is 7.5 (the remaining quantity of the promotion gain is greater than the average promotion gain). Further, if an actual promotion gain generated by the candidate promotional information after an actual second delivery is 5, when a new round of promotional information delivery is to be performed, it may be determined that the candidate promotional information currently has a first cumulative promotion gain of 15 and a cumulative promotion gain quota consumption of 7.5. Based on the above method, it may be determined that the remaining quantity of the promotion gain of the candidate promotional information in the current delivery is 7.5 (15−7.5=7.5), and therefore, the promotion gain quantity of the candidate promotional information in the current delivery is 7.5 (the remaining quantity of the promotion gain is equal to the average promotion gain). Still further, if an actual promotion gain generated by the candidate promotional information after an actual third delivery is 6. when a new round of promotional information delivery is to be performed, it may be determined that the candidate promotional information currently has a first cumulative promotion gain of 21 and a cumulative promotion gain quota consumption of 15. Based on the above method, it may be determined that the remaining quantity of the promotion gain of the candidate promotional information in the current delivery is 6 (21−15=6), and therefore, the promotion gain quantity of the candidate promotional information in the current delivery is 6 (the remaining quantity of the promotion gain is less than the average promotion gain).

As can be seen from the above process, the above method calculates the estimated value of the promotion gain generated by delivering the candidate promotional information within the first preset time period by considering both the average value of the actual promotion gains generated per delivery of the candidate promotional information within the second preset time period and the sum of the actual promotion gains that have been generated by the candidate promotional information within the first preset time period, which is used as the upper limit. In other words, the historical performance and the real-time performance of the candidate promotional information are considered in combination to perform estimation on the candidate promotional information, thereby ensuring the accuracy of estimating the promotion gain quantity, and effectively solving a problem that the promotion gain is overestimated or the estimated promotion gain quantity fluctuates sharply.

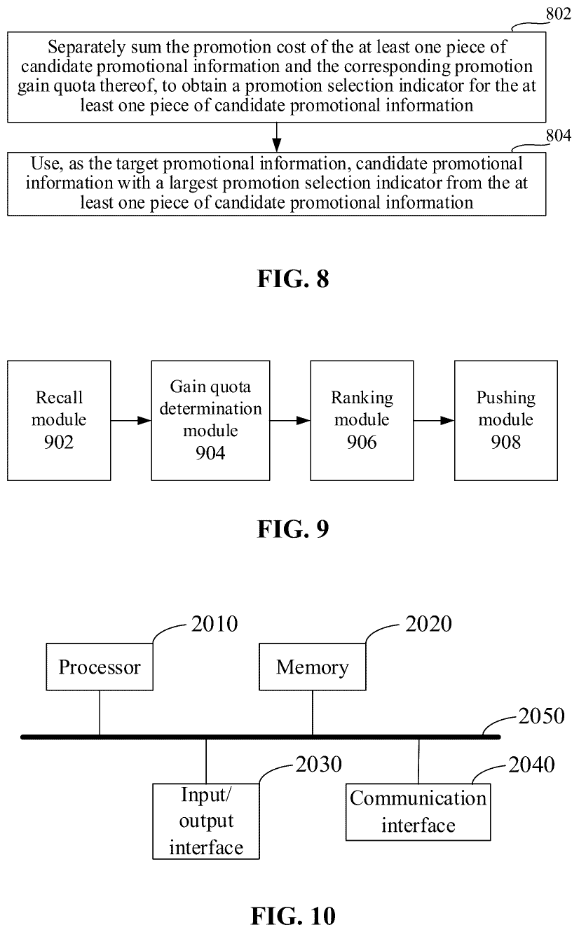

Next, after the promotion gain quantity of each piece of candidate promotional information is determined, the method may proceed to step 306 of determining the target promotional information based on the promotion cost of the at least one piece of candidate promotional information and the corresponding promotion gain quota thereof. FIG. 8 shows a procedure of implementing a method for determining target promotional information based on a promotion cost and a corresponding promotion gain quota of candidate promotional information according to some embodiments of the present disclosure. As shown in FIG. 8, a specific implementation method of step 306 may include the following steps.

At step 802, the promotion cost of the at least one piece of candidate promotional information and the corresponding promotion gain quota thereof are separately summed, to obtain a promotion selection indicator for the at least one piece of candidate promotional information.

As described above, in some embodiments, the promotion cost may be the cost per impression, e.g., ePCM, of the candidate promotional information. In this case, the promotion selection indicator S is a sum of the ePCM of the candidate promotional information and its promotion gain quota V. That is, S=ePCM+V. Certainly, in some other embodiments, the promotion cost may alternatively be a promotion cost calculated according to other rules. The specific method for calculating the promotion cost is not limited in the embodiments of the present disclosure.

In particular, as described above, if a piece of candidate promotional information does not satisfy the preset promotion condition (e.g., it is not the lead-type promotional information or does not support the affiliate promotional information), the promotion gain quota V of the candidate promotional information may be set to a preset gain value P, for example, set to 0. In this case, the promotion selection indicator S may be a sum of the ePCM of the candidate promotional information and the preset gain value P (i.e., the promotion gain quota set for the candidate promotional information), i.e., S=ePCM+P. Further, in the case where the preset gain value P is set to 0, it may be determined that S=ePCM.

At step 804, candidate promotional information with a largest promotion selection indicator from the at least one piece of candidate promotional information is used as the target promotional information.

In other words, in some embodiments, after promotion selection indicators S for the pieces of candidate promotional information are separately determined, the pieces of candidate promotional information may be sorted in descending order of the promotion selection indicators S. The candidate promotional information with the largest promotion selection indicator S finally wins, and may be determined as the target promotional information. As such, next, in step 308, the target promotional information that finally win is be fed back by the promotional information delivery platform to the corresponding client for display.

In a specific example, it is assumed that the at least one piece of candidate promotional information includes a total of five pieces of promotional information, namely, promotional information A to promotional information E. Promotion costs of the pieces of promotional information are ePCM_{A}, ePCM_{B}, ePCM_{C}, ePCM_{D}, and ePCM_{E}, respectively, and ePCM_{A}>ePCM_{B}>ePCM_{C}>ePCM_{D}>ePCM_{E}. Promotion gain quotas V of the pieces of promotional information are V_{A}, V_{B}, V_{C}, V_{D}, and V_{E}, respectively, and V_{B}>V_{C}>V_{D}>V_{E}>V_{A}. Promotion selection indicators S of the pieces of promotional information are S_{A}, S_{B}, S_{C}, S_{D}, and S_{E}, respectively, and it may be determined through a sorting operation that S_{B}>S_{A}>S_{C}>S_{D}>S_{E}. In the above situation, if a conventional policy for promotional information delivery is employed, the promotional information A may be determined as the target promotional information that wins. However, according to the promotional information delivery method described in the embodiments of the present disclosure, the promotional information B with the largest promotion gain quota, that is, with the largest estimated value of the promotion gain, may be preferentially selected as the final generated target promotional information.

According to the promotional information delivery method described in the embodiments of the present disclosure, first, the plurality of pieces of candidate promotional information that are of interest to the user may be obtained first by recall and pre-ranking after the promotional information request from the client is received. Then, an improvement is made to the existing ranking procedure, which specifically includes: predicting a promotion gain of each piece of candidate promotional information based on a promotion gain of the piece of candidate promotional information within a predetermined time period, thereby determining a promotion gain quantity of the piece of candidate promotional information. Finally, the target promotional information is selected and delivered based on a promotion cost and the promotion gain quantity of each piece of candidate promotional information.

With the promotional information delivery method described above, a promotion gain quantity can be set for promotional information, such as affiliate promotional information, that can bring a promotion gain, and therefore preferential delivery thereof is implemented. A higher promotion gain of the promotional information leads to a higher set promotion gain quantity and a higher chance of winning a delivery. In this way, the probability of delivering the promotional information, such as the affiliate promotional information, that can bring the promotion gain can be increased without an increase in the promotion cost of the promotional information, so that the competitiveness of such a type of promotional information in delivery is improved, thereby increasing overall benefits for the promotional information delivery platform. From another perspective, promotional information providers can increase the impression probability of their promotional information without paying more. For the promotional information providers, the promotion cost of the promotional information is reduced effectively in essence.

Furthermore, the promotional information, such as the affiliate promotional information, that can bring the promotion gain is often combined promotional information that combines a plurality of pieces of promotional information. In other words, the promotional information delivery method described above makes it possible to preferentially return to the client the information such as the affiliate promotional information that contains a plurality of pieces of promotional information of interest to the user, so that the user can be provided with richer information for decision making. Therefore, the delivery method also improves the efficiency and effectiveness of the promotional information delivery.

Based on the promotional information delivery method described above, an embodiment of the present disclosure further provides a promotional information delivery apparatus, an internal structure of which is shown in FIG. 9. The apparatus may include:
a recall module 902 configured to determine at least one piece of candidate promotional information after a promotional information request sent by a client is received;
a gain quota determination module 904 configured to separately determine a promotion gain quota of the at least one piece of candidate promotional information;
a ranking module 906 configured to determine target promotional information based on a promotion cost of the at least one piece of candidate promotional information and the corresponding promotion gain quota thereof; and
a pushing module 908 configured to push the target promotional information to the client.

Reference may be made to the above methods and the accompanying drawings for the specific implementation of each module, and for the implementation method of each module as well. Details are not repeated herein.

For ease of description, when described, the above apparatus is divided into various modules based on functions. Certainly, functions of the modules may be implemented in one or more pieces of software and/or hardware when the present disclosure is implemented. The apparatus in the above embodiment is configured to implement the corresponding promotional information delivery method in any one of the above embodiments, and has the beneficial effects of the corresponding method embodiment, which are not repeated herein.

Accordingly, the promotional information delivery apparatus can increase the probability of delivering the promotional information, such as the affiliate promotional information, that can bring the promotion gain, without a change in the promotion cost of the promotional information, thereby effectively reducing the overall promotion cost of the promotional information. Further, the promotional information delivery apparatus can further provide the user with more information of interest to the user in a single promotional information delivery process, thereby improving the efficiency and effectiveness of the promotional information delivery.

FIG. 10 is a schematic diagram of a hardware structure of a more specific electronic device according to an embodiment. The device may include: a processor 2010, a memory 2020, an input/output interface 2030, a communication interface 2040, and a bus 2050. The processor 2010, the memory 2020, the input/output interface 2030, and the communication interface 2040 are communicatively connected to each other within the device through the bus 2050.

The processor 2010 may be implemented using a general-purpose central processing unit (CPU), a microprocessor, an application specific integrated circuit (ASIC), or one or more integrated circuits, etc. for executing related programs, to implement the technical solutions provided in the embodiments of the specification.

The memory 2020 may be implemented using a read-only memory (ROM), a random access memory (RAM), a static storage device, a dynamic storage device, etc. The memory 2020 may store an operating system and other applications, and when the technical solutions provided in the embodiments of the specification are implemented by means of software or firmware, related program code is stored in the memory 2020 and called by the processor 2010 for execution.

The input/output interface 2030 is configured to connect to an input/output device to enable information input and output. The input/output device may be configured as a component in the device, or it may be external to the device to provide a corresponding function. The input device may include a microphone, various sensors, etc., and the output device may include a display, a speaker, a vibrator, an indicator light, etc.

The communication interface 2040 is configured to connect to a communication module (not shown) to enable communication interaction between the device and other devices. The communication module may communicate in a wired (e.g., a USB, a network cable, etc.), or wireless (e.g., a mobile network, Wi-Fi, Bluetooth, etc.) manner.

The bus 2050 includes a path for transferring information between the components (for example, the processor 2010, the memory 2020, the input/output interface 2030, and the communication interface 2040) of the device.

It should be noted that although only the processor 2010, the memory 2020, the input/output interface 2030, the communication interface 2040, and the bus 2050 are shown in the device, during a specific implementation, the device may further include other components necessary for proper operation. Furthermore, it can be understood by those skilled in the art that the device may include only the components necessary to implement the solutions provided in the embodiments of the specification, and not necessarily include all of the components shown in the figure.

The electronic device in the above embodiment is configured to implement the corresponding promotional information delivery method in any one of the above embodiments, and has the beneficial effects of the corresponding method embodiment, which are not repeated herein.

Based on the same inventive concept, corresponding to the method of any one of the above embodiments, the present disclosure further provides a non-transitory computer-readable storage medium storing computer instructions, where the computer instructions are used to cause the computer to perform the promotional information delivery method of any one of the previous embodiments.

The computer-readable medium in this embodiment includes permanent and non-permanent, removable and non-removable media and may implement information storage by using any method or technology. Information may be computer-readable instructions, data structures, modules of a program, or other data. Examples of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, or any other non-transmission media that may be used to store information capable of being accessed by a computing device.

The computer instructions stored on the storage medium of the above embodiment are used to cause the computer to perform the promotional information delivery method of any one of the above embodiments, and have the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the previous embodiments or different embodiments can also be combined, steps can be implemented in any order, many other changes can be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a dynamic RAM (DRAM).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

1. A promotional information delivery method, comprising:
determining at least one piece of candidate promotional information after a promotional information request sent by a client is received;
separately determining a promotion gain quota of the at least one piece of candidate promotional information;
determining target promotional information based on a promotion cost of the at least one piece of candidate promotional information and the corresponding promotion gain quota thereof; and
pushing the target promotional information to the client.

2. The method according to claim 1, wherein separately determining the promotion gain quota of the at least one piece of candidate promotional information comprises:
separately determining whether the at least one piece of candidate promotional information satisfies a preset promotion condition; and
in response to determining that the candidate promotional information satisfies the preset promotion condition, determining the promotion gain quota of the candidate promotional information based on a promotion gain of the candidate promotional information; or
in response to determining that the candidate promotional information does not satisfy the preset promotion condition, setting the promotion gain quota of the candidate promotional information to a preset gain value.

3. The method according to claim 2, wherein determining the promotion gain quota of the candidate promotional information based on the promotion gain of the candidate promotional information comprises:
summing promotion gains of the candidate promotional information within a first preset time period to obtain a first cumulative promotion gain corresponding to the candidate promotional information;
summing promotion gain quotas of the candidate promotional information within the first preset time period to obtain a cumulative promotion gain quota consumption corresponding to the candidate promotional information;
summing promotion gains of the candidate promotional information within a second preset time period to obtain a second cumulative promotion gain corresponding to the candidate promotional information;
determining an average promotion gain of the candidate promotional information based on the second cumulative promotion gain; and
determining the promotion gain quota of the candidate promotional information based on the first cumulative promotion gain, the cumulative promotion gain quota consumption, and the average promotion gain.

4. The method according to claim 3, wherein determining the promotion gain quota of the candidate promotional information based on the first cumulative promotion gain, the cumulative promotion gain quota consumption, and the average promotion gain comprises:
subtracting the cumulative promotion gain quota consumption from the first cumulative promotion gain to obtain a remaining quantity of the promotion gain; and
in response to the remaining quantity of the promotion gain being greater than or equal to the average promotion gain, using the average promotion gain as the promotion gain quota of the candidate promotional information; or
in response to the remaining quantity of the promotion gain being less than the average promotion gain, using the remaining quantity of the promotion gain as the promotion gain quota of the candidate promotional information.

5. The method according to claim 2, wherein determining the promotion gain quota of the candidate promotional information based on the promotion gain of the candidate promotional information comprises:
summing promotion gains of the candidate promotional information within a first preset time period to obtain a first cumulative promotion gain corresponding to the candidate promotional information;
summing promotion gain quotas of the candidate promotional information within the first preset time period to obtain a cumulative promotion gain quota consumption corresponding to the candidate promotional information; and
determining the promotion gain quota of the candidate promotional information based on the first cumulative promotion gain and the cumulative promotion gain quota consumption.

6. The method according to claim 5, wherein determining the promotion gain quota of the candidate promotional information based on the first cumulative promotion gain and the cumulative promotion gain quota consumption comprises:
subtracting the cumulative promotion gain quota consumption from the first cumulative promotion gain to obtain a remaining quantity of the promotion gain; and
using the remaining quantity of the promotion gain as the promotion gain quota of the candidate promotional information.

7. The method according to claim 2, wherein determining the promotion gain quota of the candidate promotional information based on the promotion gain of the candidate promotional information comprises:
summing promotion gains of the candidate promotional information within a second preset time period to obtain a second cumulative promotion gain corresponding to the candidate promotional information;
determining an average promotion gain of the candidate promotional information based on the second cumulative promotion gain; and
determining the promotion gain quota of the candidate promotional information based on the average promotion gain.

8. The method according to claim 1, wherein determining the target promotional information based on the promotion cost of the at least one piece of candidate promotional information and the corresponding promotion gain quota thereof comprises:
separately summing the promotion cost of the at least one piece of candidate promotional information and the corresponding promotion gain quota thereof, to obtain a promotion selection indicator for the at least one piece of candidate promotional information; and
using, as the target promotional information, candidate promotional information with a largest promotion selection indicator from the at least one piece of candidate promotional information.

9. An electronic device, comprising:
a memory,
a processor, and
a computer program stored on the memory and executable on the processor, wherein the computer program, when executed by the processor, causes the electronic device to:
determine at least one piece of candidate promotional information after a promotional information request sent by a client is received;
separately determine a promotion gain quota of the at least one piece of candidate promotional information;
determine target promotional information based on a promotion cost of the at least one piece of candidate promotional information and the corresponding promotion gain quota thereof; and
push the target promotional information to the client.

10. The electronic device according to claim 9, wherein separately determining the promotion gain quota of the at least one piece of candidate promotional information comprises:
separately determining whether the at least one piece of candidate promotional information satisfies a preset promotion condition; and
in response to determining that the candidate promotional information satisfies the preset promotion condition, determining the promotion gain quota of the candidate promotional information based on a promotion gain of the candidate promotional information; or
in response to determining that the candidate promotional information does not satisfy the preset promotion condition, setting the promotion gain quota of the candidate promotional information to a preset gain value.

11. The electronic device according to claim 10, wherein determining the promotion gain quota of the candidate promotional information based on the promotion gain of the candidate promotional information comprises:
summing promotion gains of the candidate promotional information within a first preset time period to obtain a first cumulative promotion gain corresponding to the candidate promotional information;
summing promotion gain quotas of the candidate promotional information within the first preset time period to obtain a cumulative promotion gain quota consumption corresponding to the candidate promotional information;
summing promotion gains of the candidate promotional information within a second preset time period to obtain a second cumulative promotion gain corresponding to the candidate promotional information;
determining an average promotion gain of the candidate promotional information based on the second cumulative promotion gain; and
determining the promotion gain quota of the candidate promotional information based on the first cumulative promotion gain, the cumulative promotion gain quota consumption, and the average promotion gain.

12. The electronic device according to claim 11, wherein determining the promotion gain quota of the candidate promotional information based on the first cumulative promotion gain, the cumulative promotion gain quota consumption, and the average promotion gain comprises:
subtracting the cumulative promotion gain quota consumption from the first cumulative promotion gain to obtain a remaining quantity of the promotion gain; and
in response to the remaining quantity of the promotion gain being greater than or equal to the average promotion gain, using the average promotion gain as the promotion gain quota of the candidate promotional information; or
in response to the remaining quantity of the promotion gain being less than the average promotion gain, using the remaining quantity of the promotion gain as the promotion gain quota of the candidate promotional information.

13. The electronic device according to claim 10, wherein determining the promotion gain quota of the candidate promotional information based on the promotion gain of the candidate promotional information comprises:
summing promotion gains of the candidate promotional information within a first preset time period to obtain a first cumulative promotion gain corresponding to the candidate promotional information;
summing promotion gain quotas of the candidate promotional information within the first preset time period to obtain a cumulative promotion gain quota consumption corresponding to the candidate promotional information; and
determining the promotion gain quota of the candidate promotional information based on the first cumulative promotion gain and the cumulative promotion gain quota consumption.

14. The electronic device according to claim 13, wherein determining the promotion gain quota of the candidate promotional information based on the first cumulative promotion gain and the cumulative promotion gain quota consumption comprises:
subtracting the cumulative promotion gain quota consumption from the first cumulative promotion gain to obtain a remaining quantity of the promotion gain; and
using the remaining quantity of the promotion gain as the promotion gain quota of the candidate promotional information.

15. The electronic device according to claim 10, wherein determining the promotion gain quota of the candidate promotional information based on the promotion gain of the candidate promotional information comprises:
summing promotion gains of the candidate promotional information within a second preset time period to obtain a second cumulative promotion gain corresponding to the candidate promotional information;
determining an average promotion gain of the candidate promotional information based on the second cumulative promotion gain; and
determining the promotion gain quota of the candidate promotional information based on the average promotion gain.

16. The electronic device according to claim 9, wherein determining the target promotional information based on the promotion cost of the at least one piece of candidate promotional information and the corresponding promotion gain quota thereof comprises:
separately summing the promotion cost of the at least one piece of candidate promotional information and the corresponding promotion gain quota thereof, to obtain a promotion selection indicator for the at least one piece of candidate promotional information; and
using, as the target promotional information, candidate promotional information with a largest promotion selection indicator from the at least one piece of candidate promotional information.

17. A computer program product, comprising computer program instructions that, when executed on a computer, cause a computer to:
determine at least one piece of candidate promotional information after a promotional information request sent by a client is received;
separately determine a promotion gain quota of the at least one piece of candidate promotional information;
determine target promotional information based on a promotion cost of the at least one piece of candidate promotional information and the corresponding promotion gain quota thereof; and
push the target promotional information to the client.

18. The computer program product according to claim 17, wherein separately determining the promotion gain quota of the at least one piece of candidate promotional information comprises:
separately determining whether the at least one piece of candidate promotional information satisfies a preset promotion condition; and
in response to determining that the candidate promotional information satisfies the preset promotion condition, determining the promotion gain quota of the candidate promotional information based on a promotion gain of the candidate promotional information; or
in response to determining that the candidate promotional information does not satisfy the preset promotion condition, setting the promotion gain quota of the candidate promotional information to a preset gain value.

19. The computer program product according to claim 18, wherein determining the promotion gain quota of the candidate promotional information based on the promotion gain of the candidate promotional information comprises:
summing promotion gains of the candidate promotional information within a first preset time period to obtain a first cumulative promotion gain corresponding to the candidate promotional information;
summing promotion gain quotas of the candidate promotional information within the first preset time period to obtain a cumulative promotion gain quota consumption corresponding to the candidate promotional information;
summing promotion gains of the candidate promotional information within a second preset time period to obtain a second cumulative promotion gain corresponding to the candidate promotional information;
determining an average promotion gain of the candidate promotional information based on the second cumulative promotion gain; and
determining the promotion gain quota of the candidate promotional information based on the first cumulative promotion gain, the cumulative promotion gain quota consumption, and the average promotion gain.

20. The computer program product according to claim 19, wherein determining the promotion gain quota of the candidate promotional information based on the first cumulative promotion gain, the cumulative promotion gain quota consumption, and the average promotion gain comprises:
subtracting the cumulative promotion gain quota consumption from the first cumulative promotion gain to obtain a remaining quantity of the promotion gain; and
in response to the remaining quantity of the promotion gain being greater than or equal to the average promotion gain, using the average promotion gain as the promotion gain quota of the candidate promotional information; or
in response to the remaining quantity of the promotion gain being less than the average promotion gain, using the remaining quantity of the promotion gain as the promotion gain quota of the candidate promotional information.
